(19) United States
(12) Patent Application Publication
(10) Pub. No.: US 2017/0020118 A1
(43) Pub. Date: Jan. 26, 2017

(54) Low profile fishing rod guide system

(71) Applicant: John Paul Anderson, Waco, TX (US)

(72) Inventor: John Paul Anderson, Waco, TX (US)

(21) Appl. No.: 15/163,090

(22) Filed: May 24, 2016

Related U.S. Application Data
(60) Provisional application No. 62/170,974, filed on Jun. 4, 2015.

(51) Int. Cl. A01K 87/04

(52) U.S. Cl. CPC A01K 87/04

(57) ABSTRACT

A fishing low profile flexible fishing line guide system with direct attachment to a fishing rod.

### CROSS-REFERENCE TO RELATED APPLICATIONS

62/170,974

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of outdoor recreational equipment.

More particularly, the present invention is in the technical field of fishing rods and accessories.

Prior art teaches fishing rod eyelets also known as rod guides that abuts from the fishing rod at some distance usually separated by a mechanical attachment device setting the distance. The result is an eyelet that may be many centimeters distant from the rod. In such a design the fishing line passing through said eyelets is susceptible to tangling on foreign objects in the sport of fishing, such as adjacently stored rods and their lines, vegetation, and tools and accessories. Additionally eyelets positioned and designed in this manner are more susceptible to themselves breaking or becoming detached from the fishing rod, again by contact with other rods stored or transported in close proximity as is frequently practiced, or encountering other foreign objects.

### SUMMARY OF THE INVENTION

The present invention is a rod guide for integration or attachment to fishing rods, supporting and directing the fishing line down the axis of the rod in channeled guides to the terminus having a low profile alignment to the rod avoiding or reducing line entanglement during storage and transport of the fishing rod and eliminating eyelet breakage. The line passes through the guides from its source, typically a reel, to the terminus of the rod as taught in prior art.

However, unlike prior art the design of the present guide greatly minimizes the distance between the rod and the line by creating channels directly adjacent to the rod. Minimizing the distance between the line and rod reduces the opportunity for the fishing line to catch or “snag” on foreign objects which would impede the use of the rod and line. Additionally eyelets positioned and designed in this manner—including “micro-guides” that are low profile in relation to the rod but still abut the rod—are susceptible to themselves breaking, bending or becoming detached from the fishing rod. These incidents are common by contact with other rods stored or transported in close proximity as is frequently practiced, or encountering other foreign objects during casting in close quarters such as a boat or on a dock or pier. Broken eyelets will remove the rod from a useable state until the eyelet can be replaced or repaired, assuming it is reparable, adding time and expense to maintain the fishing rod or requiring replacement of the rod in its entirety, in addition to the rod being out of service until the repair can be made. The mere time out of service for a rod from broken eyelets can be extremely detrimental when you consider professional and amateur anglers competing in tournaments that may offer significant financial rewards, and require financial entry fees. Even for hobbyists the costs of fishing trips and family outings that are terminated or truncated due to broken equipment can be significant monetarily and in lost experiences.

### BRIEF DESCRIPTION OF THE DRAWINGS

FIG. 1 is a cross-sectional view of the present invention;

FIG. 2 is a side view of a of the present invention;

FIG. 3 is a perspective view of the present invention.

### DETAILED DESCRIPTION OF THE INVENTION

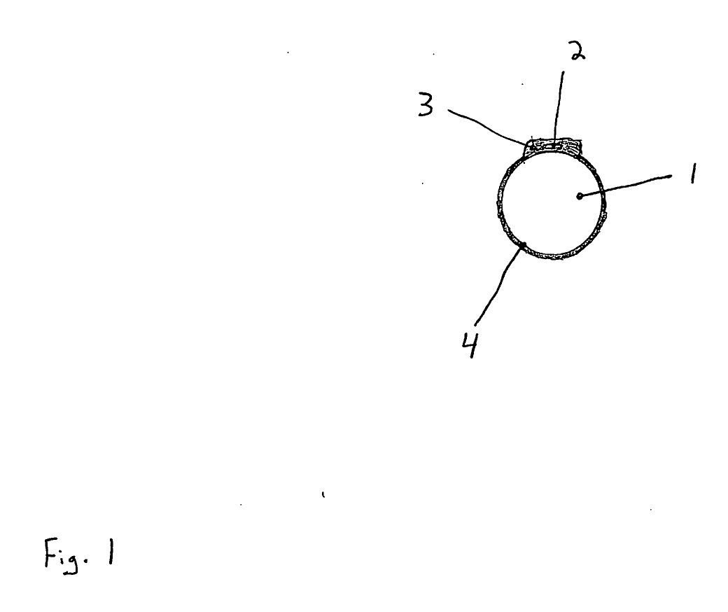

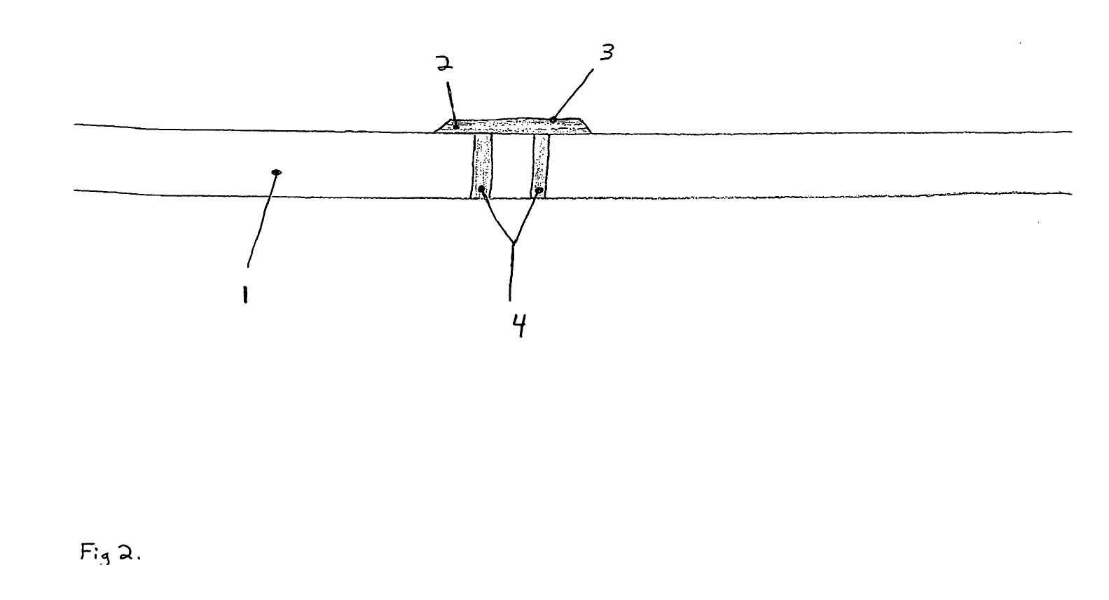

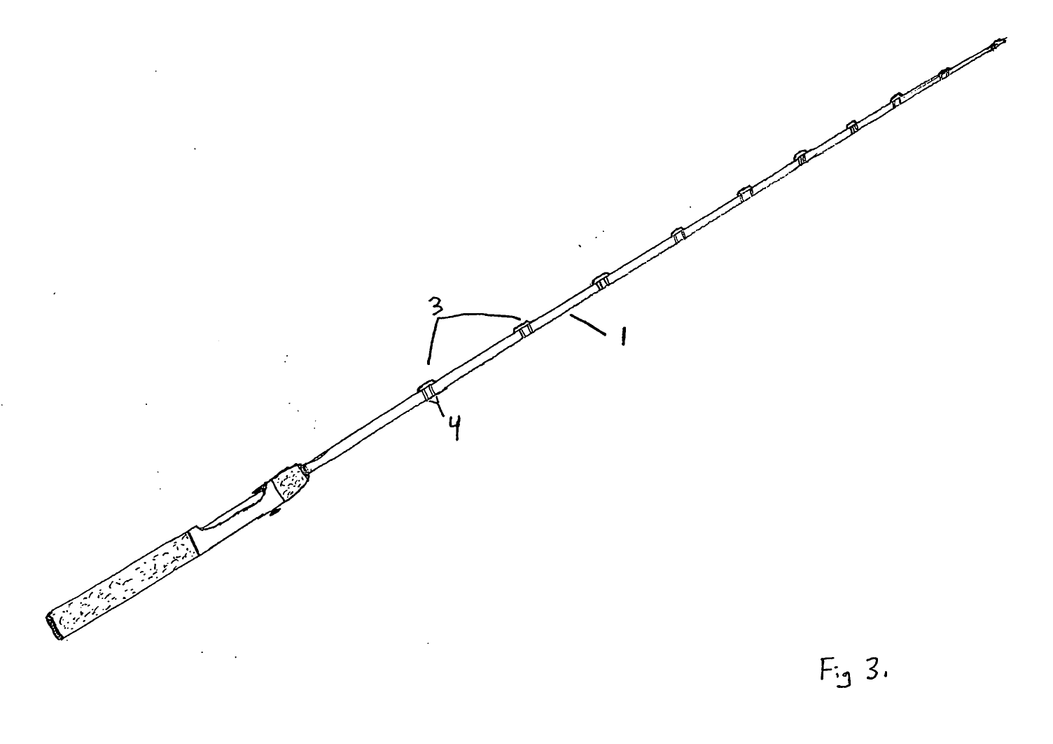

Referring now to the invention in more detail, in FIG. 1 to FIG. 2 there is shown a low profile guide system channel. In each figure, the rod to which the channel is attached to its exterior for the purpose of guiding the line is numbered 1, the central cavity in which the fishing line is threaded is numbered 2, and the primary structure of the channel itself is numbered as 3, and the preferred embodiment of attachment by ringlet is numbered as 4, seen best in FIG. 2 and FIG. 3. FIG. 3 offers a perspective view of a channel as it might appear on a fishing rod 1 attached by ringlets 4 and spaced approximate one foot apart down the axis of the rod 1. A central cavity 2 is essential for the passage of the fishing line through the channel.

In more detail, still referring to the guide system of FIG. 1 to FIG. 2 the channel 3 is attached to the rod 1 by means of duel ringlets 3. The channel 3, may be made out of any sufficiently elastic material (to enable bending and flexing with the attached rod 1 under a load such as a hooked fish) that is able to maintain its structure and that of the central cavity 2 for the passage of a fishing line; examples of such materials are shape-memory alloys such as nitinol or polymers such as or polytetrafluoroethylene. Optionally, the channel may be coated, particularly with respect to the central cavity 2 with a friction reducing film.

In further detail, still referring to the invention of FIG. 1 to FIG. 2. we see the channel 3 is many millimeters in length, a preferred embodiment would be approximately 18-30 millimeters for a typical application, and attached to the rod 1. The central cavity 2 runs the distance of the guide allowing for a fishing line to traverse from end to end. The cavity 2 may be beveled and conical at its openings to facilitate feeding through fishing line. As seen in FIG. 3 the forward and rear edges 5 of the channel 3 have a slope less than a 90 degree angle to further reduce snagging. The height or width of 3 may vary by application with larger rods using heavier and thicker lines necessarily being scaled larger while maintaining the utility of the low profile design and being otherwise essentially flat. The ventral edge 7 of the guide 2 is machined to fit the shape of the underlying rod 1 and is generally concave in shape to be flush with the rod 1, thus reducing opportunities for foreign objects getting between guide 2 and rod 1.

Referring now to the invention shown in FIG. 3 we see a multitude of channels 2 secured to rod 1 along its length as an example of the invention being practiced as a guide system.

The advantages of the present invention include, without limitation, increased durability of fishing line guides due to their low profile and reduced opportunity to snag and break during transit, storage, or use with the resulting additional advantage of reducing the exposure of the fishing line to tangles, snags, and overlaps with lines of adjacently stored rods.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A fishing line guide system comprising:
a. a plurality of channels aligned in parallel down the length of a fishing rod where:
i. the channels are flat with sufficient width to allow a cavity that a fishing line can traverse;
ii. each channel has a ventral edge that is flush in contact with the fishing rod;
iii. each channel is manufactured from a flexible or elastic material;
iv. each channel is secured to the rod by ringlets.

2. The invention in claim 1 where the ventral edge of the channel is concave

3. The invention in claim 1 where the channels are coated with friction reducing materials.

4. The invention in claim 1 where each channel is beveled edge with a slope of less than 90 degrees at the anterior and posterior of each channel.

5. The invention of claim 1 where each channel has a beveled, conical entrance to the central cavity.

6. The invention of claim 1 where each channel has a beveled anterior and posterior edge with a slope of less than 90 degrees, a conical shaped entrance bore to the central cavity, and a concave ventral edge abutting the fishing rod.

7. The invention of claim 6 where the channels are coated with friction reducing materials.
